(19) United States
(12) Patent Application Publication
(10) Pub. No.: US 2013/0014058 A1
(43) Pub. Date: Jan. 10, 2013

(54) Security System

(75) Inventors: Andrew David Scothern, Hamilton (NZ); Steven John Bell, Hamilton (NZ)

(73) Assignee: GALLAGHER GROUP LIMITED, Hamilton (NZ)

(21) Appl. No.: 13/177,636

(22) Filed: Jul. 7, 2011

(51) Int. Cl. G06F 3/048

(52) U.S. Cl. 715/835

(57) ABSTRACT

The present invention relates to a security system.

### TECHNICAL FIELD

The present invention relates to a security system.

### BACKGROUND ART

Security systems are becoming increasingly complex and sophisticated in terms of the information obtained and monitored by the devices forming that system such as cameras, access controllers, scanners, and so on.

Numerous Physical Security Information Management (PSIM) systems are available for the management of such systems. These PSIM systems receive and process feeds from the various elements making up the security system in order to provide operators with information as to the operation of these devices, and alert them to alarms being issued.

Each security system user has different priorities in terms of the importance of certain areas, or types of alarms being issued.

While PSIM systems are advertised as being customisable to individual requirements, in the experience of the applicants this necessitates hard coding of the software in order to do so. This can be a time consuming and thus expensive process.

Further, if modifications to the security system are subsequently desired, or experience demands a change in functionality of the management software, these changes must be performed by the provider—adding to the expense. The associated time delays in contacting the provider, explaining the desired changes and subsequently making those changes can present a security issue in the meantime. At the very least the procedure is an inconvenience to the user.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DISCLOSURE OF THE INVENTION

According to one aspect of the present invention there is provided a security system, comprising:
a plurality of security devices configured to output at least one signal relating to operation of those devices;
a processor configured to process the output signals to obtain information relating to operation of the devices;
a display device;
a graphical user interface configured to:
   instruct the display device to display a number of tiles,
   wherein the tiles contain content derived from the information relating to the operation of the devices,
   and wherein the graphical user interface is configured to enable external input to the system by a user to determine the tiles to be displayed on the display device and/or content thereof.

According to another aspect of the present invention there is provided a method of configuring a security system comprising a plurality of security devices configured to output at least one signal relating to operation of those devices, a processor configured to process the output signals to obtain information relating to operation of the devices, a display device, a graphical user interface configured to instruct the display device to display a number of tiles, wherein the tiles contain content derived from the information relating to the operation of the devices, the method comprising:
a user inputting via the graphical user interface the tiles to be displayed on the display device and/or content thereof.

According to another aspect of the present invention there is provided a method of operating a security system comprising:
outputting at least one signal from a plurality of security devices, wherein the at least one signal relates to operation of those devices;
processing the output signals to obtain information relating to operation of the devices;
displaying a number of tiles on a display device, wherein the tiles contain content derived from the information relating to the operation of the devices, and wherein the tiles to be displayed on the display device and/or content thereof are determined by receiving external input by a user via a graphical user interface.

According to another aspect of the present invention there is provided a graphical user interface configured to display a number of tiles via a display device,
wherein the tiles contain content derived from information relating to the operation of a plurality of security devices, the information obtained by processing at least one signal output by the security devices,
and wherein the graphical user interface is configured to enable external input by a user to determine the tiles to be displayed on the display device and/or content thereof.

Preferably, the input by the user forms part of initialisation of the security system. Reference to initialisation should be understood to mean the process of preparing the system prior to its implementation. In other words, the input to determine the tiles and/or content thereof to be displayed is provided before the security system is activated to monitor and protect the site.

It should be appreciated that initialisation is not limited to only one point in time, but that the system may be effectively re-initialised as the needs or preferences of the owners/users of the system change.

It should be appreciated that the security devices used by the system of the present invention may be any known within the security industry—for example Digital or Network Video Recorder (DVR or NVR) cameras, card readers, perimeter (fence) systems, biometric access control systems, intercoms, intrusion detectors such as Passive infrared (PIR) sensors, window switches or glass breakage sensors, and so on.

Reference to a tile should be understood to mean a distinct object on a graphical display. It is envisaged that the tiles will be displayed within a panel on the graphical user interface, the bounds and positioning of which when displayed by the display device may be defined by the user.

It is also envisaged that the content of the tiles may be provided by third party applications such as a DVR camera feed. In providing this functionality, the view presented to an operator may integrate all desired security monitoring functions into a single package—avoiding the need to navigate through separate application windows.

It should be appreciated that the various components of the graphical user display may be configured to be displayed across multiple display devices if so desired.

In a preferred embodiment the graphical user display is configured to present selectable options to the user to define conditions under which the tiles and/or content thereof are displayed on the display device.

It should be appreciated that the mechanism by which the selectable options are presented may be achieved by any suitable means known to a person skilled in the art of using a graphical user interface. By way of example, the selectable options may be presented in a drop down menu, checkboxes, buttons, and so on.

Similarly, the means by which the user selects those options may be achieved by any suitable means known in the art—for example wherein the display device is a touchscreen, or an input device such as a mouse is used.

Reference to a condition should be understood to mean a factor determining the performance or outcome of a process. A condition in the context of the present invention might also be understood as a rule—if particular factors are present, a predefined action is taken.

It should be appreciated that a condition need not be limited to an event which occurs at a particular place and time. For example, the condition may be the absence of a signal from one of the security devices, whether instantaneously or over a predetermined amount of time.

A specific example of this may be a door being left open for too long. The event of the door being opened may not be sufficient to be considered a condition, however that door being left opened beyond a set time threshold may be a condition.

It is envisaged that in some instances the conditions define a set of rules which when met result in the automatic display or refreshing of tiles and/or content therein.

Alternatively, in a preferred embodiment the graphical user interface is configured to:
cause the display device to display a number of headings related to an aspect of the operation of the security system; and
receive external input from a user to select a heading; and
display tiles relating to the selected heading, wherein the relationship between the displayed tiles and heading are input to the system by the user via the graphical user interface.

In this case the condition is the manual selection of a heading, causing tiles associated with that heading to be displayed.

Preferably the selectable options comprise options for designation of the tiles and/or content to be displayed in response to determination of an alarm condition within the information relating to operation of the devices.

An alarm condition should be understood to mean any set of predefined conditions which have been determined to be of interest to the security of the area or location that the security system is intended to monitor and maintain. For example, an alarm condition may be:
Attempted access to an area without authorisation;
Forced entry through a door without access being granted;
Expiry of the credentials of a card-user attempting to gain access;
An accessway such as a door being left open beyond a set period of time;
Motion detected in a sealed area;
Devices such as controllers, or readers, offline;
Equipment tampered with (e.g. cover removed);
An alarm from a third party system (e.g. DVR camera motion detection);
Attempted breach of a fence—whether scaling or cutting of wires; or
An emergency button pushed (fire, duress, etc.).

It should be appreciated that the present invention may also implement the techniques or configurations discussed with reference to alarm conditions to other events within the operation of the security system which are not directly associated with the security devices.

Preferably the selectable options comprise options for selecting a priority of a type of alarm condition.

Each alarm may be assigned an alarm type, categorising that alarm according to any set of criteria deemed relevant by the user. For example, an alarm notifying that an authorized user has gained access to an area and an alarm that access has been manually authorised by an operator may both be considered ‘Door Access Granted’ types. It should be appreciated that an alarm type may also be described as an event type within the specification—where an event may occur and be recorded by the security system while not necessarily raising an alarm.

A collection of conditions, alarms, or alarm types may be defined as an event or alarm group sharing the same characteristics or dealing with related subject matter. For example, an ‘expired credentials’ alarm may be grouped with a ‘restricted access’ alarm into an ‘access denied’ group.

Other examples include:
‘Access Denied—covering alarm types for all reasons a cardholder might have been denied access to a door;
‘Command Centre Comms’ Interrupted—covering alarms relating to different equipment and services going offline; or
‘Duress’—covering alarms raised from a different source that mean someone is under duress and needs help.

It is envisaged that in some embodiments of the present invention at least one tile may be defined as an alarm viewer by the user. This alarm viewer may be configured to be positioned outside of the panel discussed above, in effect forming a distinct object or panel in its own right. It is envisaged that alarms may be presented in the alarm viewer as a list, together with columns of data or information associated with the alarm. Preferably the columns to be presented are selected by the user. The list of alarms may be sorted according to each column—whether priority, occurrence time etc.

Selection of an alarm from the alarm viewer may cause a selected grouping of tiles, or panel as discussed further below, to be presented. Alternatively, the issuance of a higher priority alarm may cause that panel to be displayed automatically.

Preferably the selectable options comprise an option as to whether to display only escalated alarm conditions. Reference to an escalated alarm condition should be understood to mean an alarm condition for which the severity has increased. This may be the result on an alarm going unaddressed or unacknowledged for a preset period of time, additional activity occurring in relation to elements associated with the alarm, or any other factor considered relevant to an alarm's severity.

In a preferred embodiment, a specific collection of tiles may be selected by the user to be associated with an alarm group and type combination. This collection of tiles may be referred to as a panel throughout the specification.

Each tile within the panel may be manipulated in terms of size and location within the panel. It is envisaged that this may be achieved by any suitable means known within the art, such as selecting and dragging. While this technique is known in graphical user interfaces generally, in the context of security management this is particularly useful in order to ensure that the display is optimised for the security system being monitored, and the operators thereof.

In enabling this, the time and cost associated with a third party coming to perform these tasks may be saved, and enable the security system manager to respond quickly to their own changing requirements.

The type of content of the individual tiles may be selected by the user according to the requirements of the specific security system or division. For example, a ‘Door Open too Long’ panel for a first organisation may be configured to comprise an ‘Alarm Details’ tile describing various details about the alarm, a ‘Cardholder Details’ tile having details about the cardholder who last accessed the door, and a ‘DVR camera’ tile displaying a view of the door. A second organisation may also create a ‘Door Open too Long’ panel comprising an ‘Alarm Details’ tile and a ‘Cardholder Details’ tile—but without the camera tile, and a more limited number of details in the other tiles.

In a preferred embodiment the content of at least one tile comprises instructions for responding to an alarm condition.

Preferably the selectable options comprise options for designation of operators of the system for whom the tiles and/or content associated with a particular condition are displayed.

Designation of the operator may utilise a unique ID such as a login and/or password to identify an operator on accessing the system, and tailor their graphical user interface according to the conditions set. Alternatively, the designation may relate to a particular workstation.

Preferably the selectable options comprise an option for selecting at least one area of a site in which the security devices are located to associate with a particular condition.

For example, a security division or operator may be allocated responsibility for a particular area of a site—such as an administration building or warehouse, or a perimeter fence. Specifying that area or areas as a condition means that the operator or division only receives alarms relevant to their area of responsibility.

Similarly, tiles presenting a site plan may then be configured to display plans focusing on those areas, enabling more accurate monitoring and decision making.

For a firmware and/or software (also known as a computer program) implementation, the techniques of the present invention may be implemented as instructions (for example, procedures, functions, and so on) that perform the functions described. It should be appreciated that the present invention is not described with reference to any particular programming languages, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers and network connections as known in the art.

The steps of a method, process, or algorithm described in connection with the present invention may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The present invention provides a number of advantages over the prior art, including:
Providing an intuitive interface utilising concepts familiar to most computer users enables a complex configuration to be performed in an easy and straightforward manner;
Rapid reconfiguration in response to changing needs without the time or monetary costs of employing a third party;
Improved decision making during operation of the security system by ensuring that operators are consistently presented with the right data in the right form. This minimizes chances of an operator missing events or information that they should be viewing;
Ease of integration of information of third party devices into the security system by presenting applications associated with the devices in tiles within a panel as opposed to a separate view or window; or
Ability to customise user interface according to available physical resources through enabling allocation of particular functions to dedicated monitors or displays—e.g. cardholder management on one monitor with alarms on another, or alarms on one monitor and site surveillance on another.

### BRIEF DESCRIPTION OF THE DRAWINGS

Further aspects of the present invention will become apparent from the ensuing description which is given by way of example only and with reference to the accompanying drawings in which:

FIG. 1 provides a general schematic of a security system in accordance with one embodiment of the present invention;

FIG. 2 illustrates a general configuration menu in accordance with an embodiment of the present invention;

FIG. 3 illustrates an alarm viewer configuration menu in accordance with an embodiment of the present invention;

FIG. 4 illustrates a panel assignment menu in accordance with an embodiment of the present invention;

FIG. 5 illustrates a graphical user interface in accordance with an embodiment of the present invention;

FIG. 6 illustrates a tile configuration menu in accordance with an embodiment of the present invention;

FIG. 7 illustrates a graphical user interface in accordance with another embodiment of the present invention;

FIG. 8 illustrates a graphical user interface in accordance with a further embodiment of the present invention, and

FIGS. 9a, 9b illustrate graphical user interfaces in accordance with a further embodiment of the present invention.

### BEST MODES FOR CARRYING OUT THE INVENTION

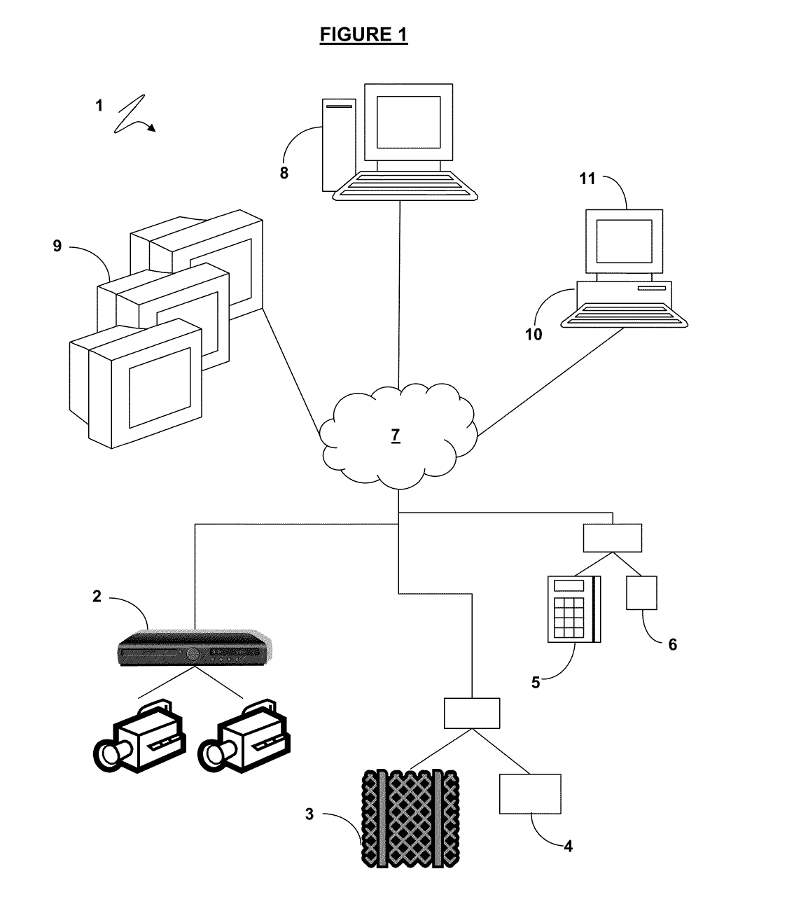

FIG. 1 illustrates a security system (generally indicated by arrow 1) according to one embodiment of the present invention.

The security system (1) comprises a plurality of security devices—for example DVR cameras (2), fence tampering sensors (3), disturbance sensors (4), swipe card readers (5) and proximity readers (6)—each configured to output at least one signal relating to operation of those devices.

The signal is sent over a network (7) to a server (8) comprising a processor configured to process the output signals to obtain information relating to operation of the devices. In particular, the information relates to whether alarm conditions or events have been detected by the security devices.

Security operator stations (9) are configured to display an operator graphical user interface having a number of tiles conveying relevant information relating to operation of the security devices to security operators.

A security manager workstation (10) is also provided, configured to display a command graphical user interface enabling external input to the system (1) by a security manager to determine the tiles to be displayed on the security operator stations (9) and/or content thereof.

Configuration and operation of the graphical user interfaces will be discussed further below.

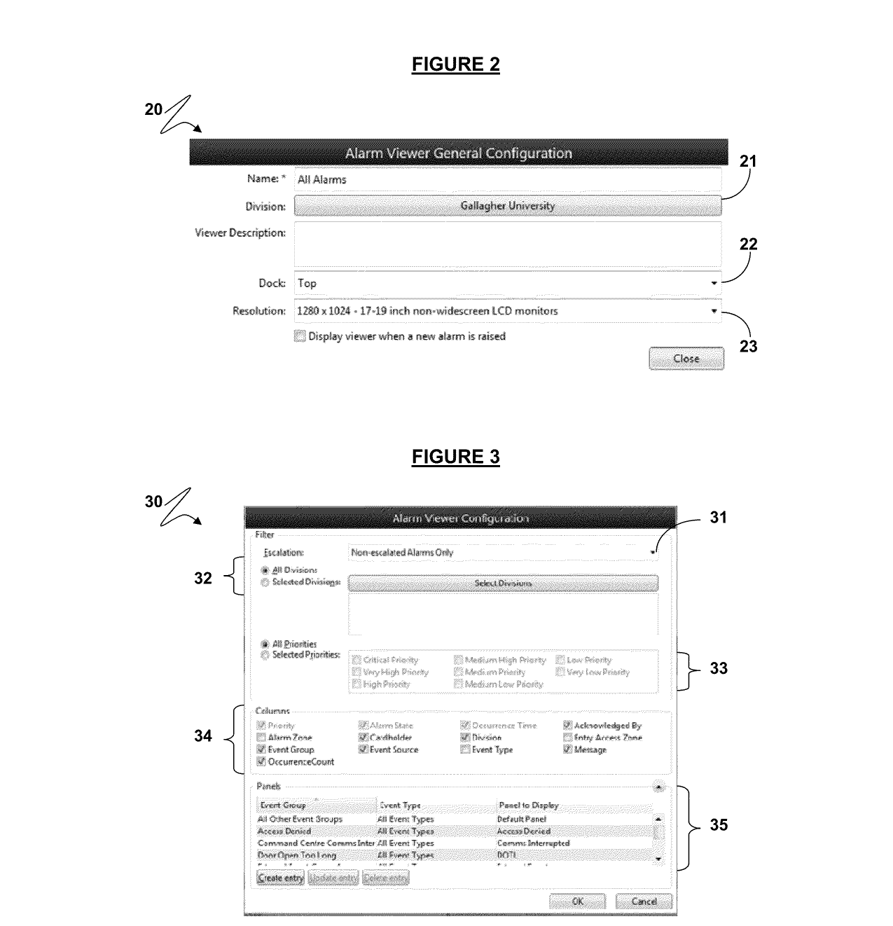

FIG. 2 illustrates a general configuration menu (generally indicated by arrow 20) for an alarm viewer in accordance with one embodiment of the present invention.

The menu (20) enables the security manager to select which operators, or division of operators can view the alarm viewer via a division selection tab (21). The security manager may also select the location of the viewer on the operator's display via a docking selection tab (22), and resolution (23).

Once the general configuration of an alarm viewer is established, the security manager may define the conditions or rules for what information is to be displayed to the operators.

FIG. 3 illustrates an alarm viewer configuration menu (generally indicated by arrow 30) in accordance with one embodiment of the present invention.

The menu (30) enables the security manager to select, by way of example:
Whether only escalated alarms are to be displayed (31);
Which areas of a site alarms are to be displayed for by division (32);
What priority of alarms are to be displayed (33);
What columns are to be displayed for each alarm in the alarm viewer (34); and
What panel is to be displayed for each alarm type (35).

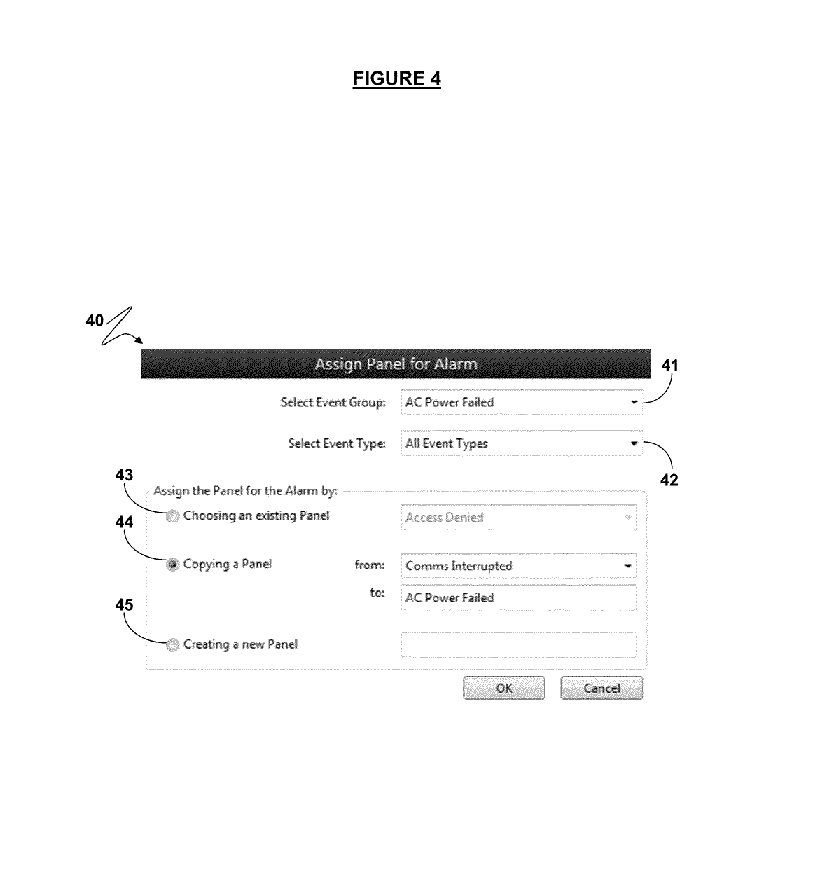

FIG. 4 illustrates a panel assignment menu (generally indicated by arrow 40) in accordance with one embodiment of the present invention.

The menu (40) enables the security manager to select, by way of example:
which panel is to be displayed for Event Group (41)/Event Type (42) combination;
Display an existing panel for a new rule combination (43);
Take a copy of an existing panel to modify for a rule combination (44);
Create a new panel to be displayed for combination (45); or
Have a default panel which is applied if a more specific rule cannot be found (so a panel is always displayed).

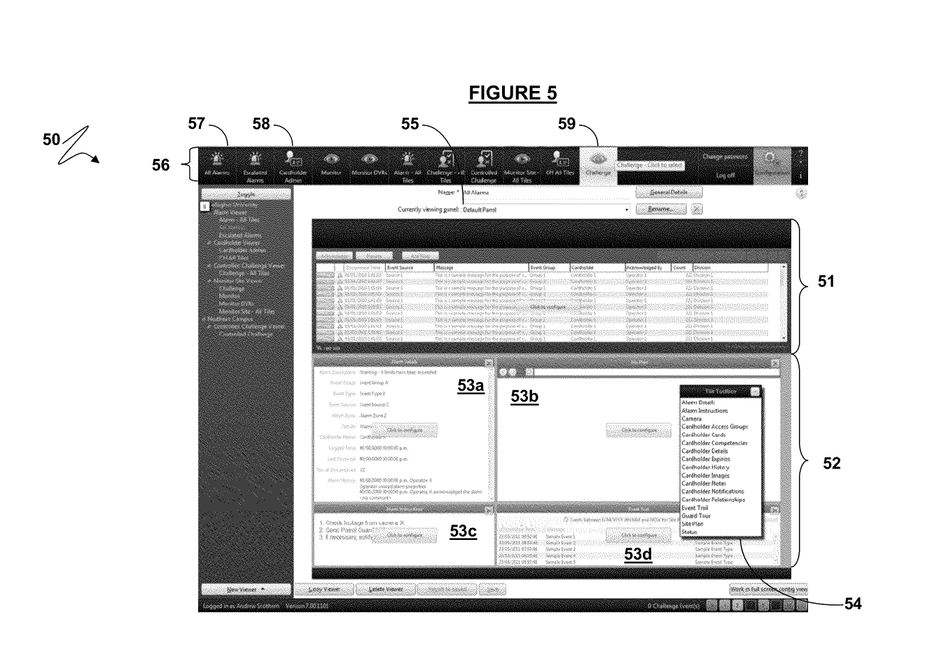

FIG. 5 illustrates a command graphical user interface (generally indicated by arrow 50) in accordance with one embodiment of the present invention.

The command graphical user interface (50) comprises an alarm list (51), and a panel (52). The panel (52) comprises a number of tiles (53a, 53b, 53c, 53d) to display content relating to operation of the security devices in accordance with the rules previously established by the security manager.

Each tile (53a, 53b, 53c, 53d) may be repositioned within the panel (52) by selecting and dragging it to its desired position. Each tile (53a, 53b, 53c, 53d) may also be resized by selecting an edge and dragging it accordingly.

Each tile (53a, 53b, 53c, 53d) may be selected in order to provide options for configuring its content.

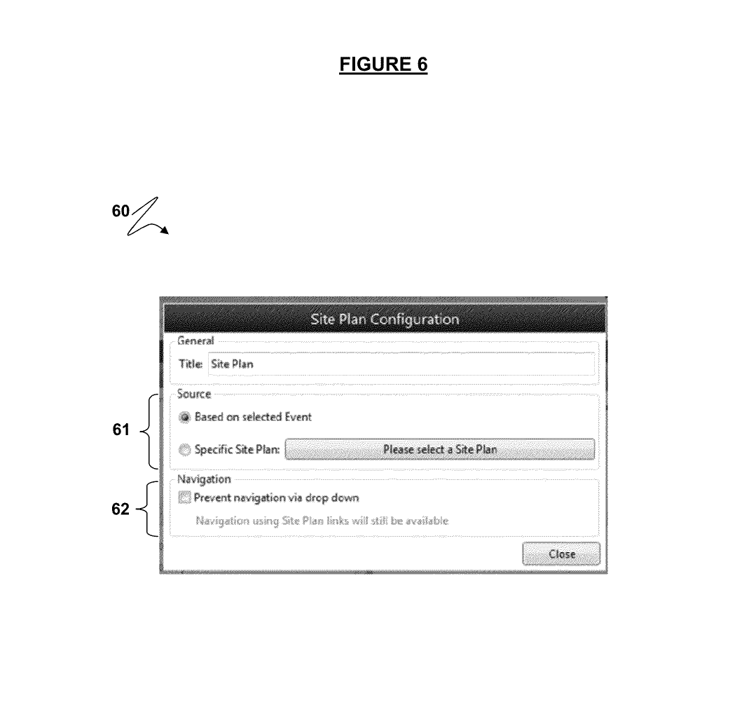

FIG. 6 provides an example of such options in the form of a ‘Site Plan’ tile configuration menu (generally indicated by arrow 60). The menu (60) enables the security manager to select which site plan to display (61), and navigation behavior when it is displayed (62). It is envisaged that a preview of the tile in accordance with any changes made will be displayed in order to assist with sizing and layout within the panel (52)

Returning to FIG. 5, additional tiles may be selected from a tile toolbox (54) to be added to the panel (52).

Other panels to be modified may be selected from a panel selection dropdown menu (55).

The command graphical user interface (50) also comprises a heading menu (56) containing a number of selectable headings—comprising ‘All Alarms’ (57), ‘Cardholder Admin’ (58), and ‘Challenge’ (59). Each heading may have a separate set of functions associated with management of the security system (1) to be configured by the security manager.

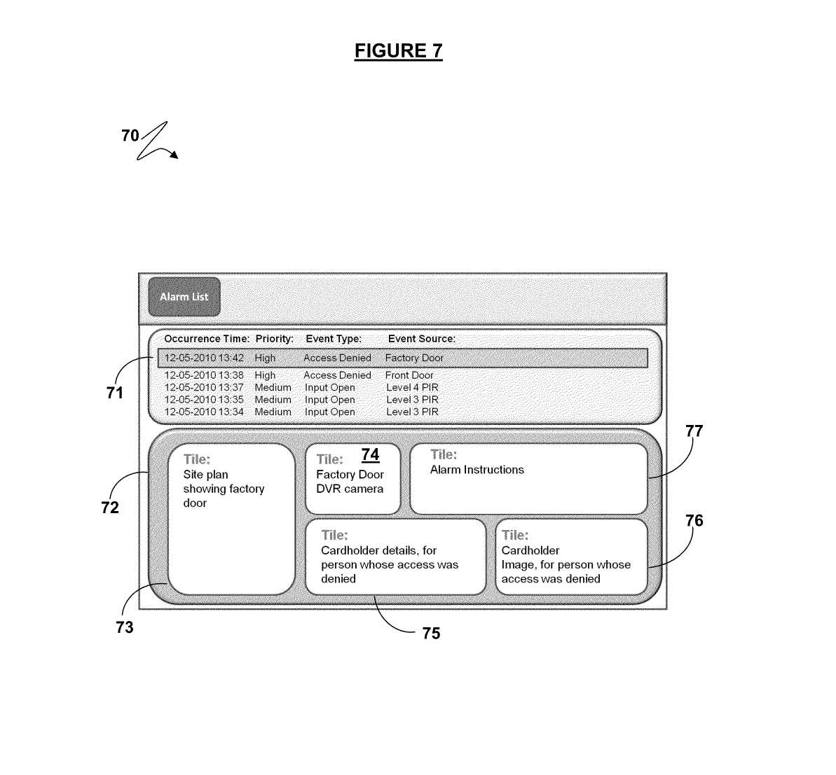

FIGS. 7, 8 and 9 provide examples of operator graphical user interfaces (70, 80, 90) produced using the command graphical user interface (50) as generally described with reference to FIGS. 2-6.

In FIG. 7, the operator graphical user interface (70) shows that a high priority alarm has issued due to access being denied at the factory door.

The panel (72) displays tiles comprising:
A site plan comprising the factory door (73);
A view from a DVR camera located at the factory door (74);
Details of the cardholder whose access was denied (75);
An image of the cardholder for comparison to the camera image (76); and
Instructions for responding to the alarm (77).

For an installation where a site plan was not available, the tiles containing DVR camera and cardholder images (74, 76) may have been rearranged to be larger in order to maximize the space available. Alternatively, the security manager may have positioned the tiles containing DVR camera and cardholder images (74, 76) directly adjacent to each other in order to facilitate comparison between them.

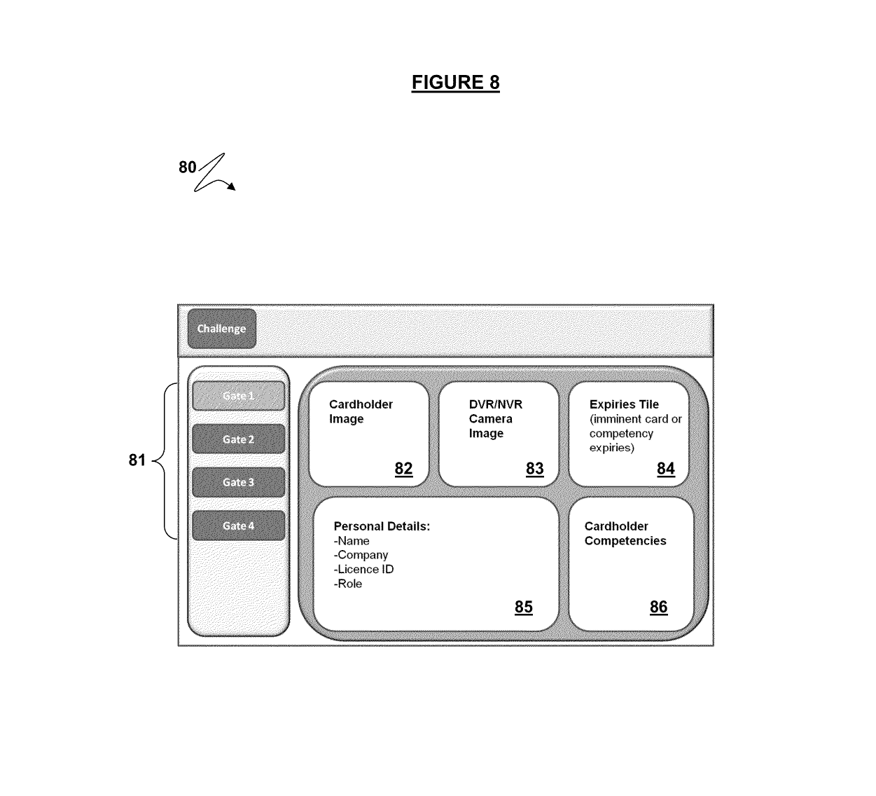

In FIG. 8, the operator graphical user interface (80) provides information relating to an access event occurring at one of a number of gates (81).

The tiles selected by the security manager to be displayed in relation to ‘Gate 1’ comprise:
Cardholder Image(s) (82);
DVR camera(s) from one or both sides of the door (83);
Expiries (to inform the cardholder of imminent expiries) (84);
Cardholder competencies, cards or access (85); and
Cardholder name and personal details (86).

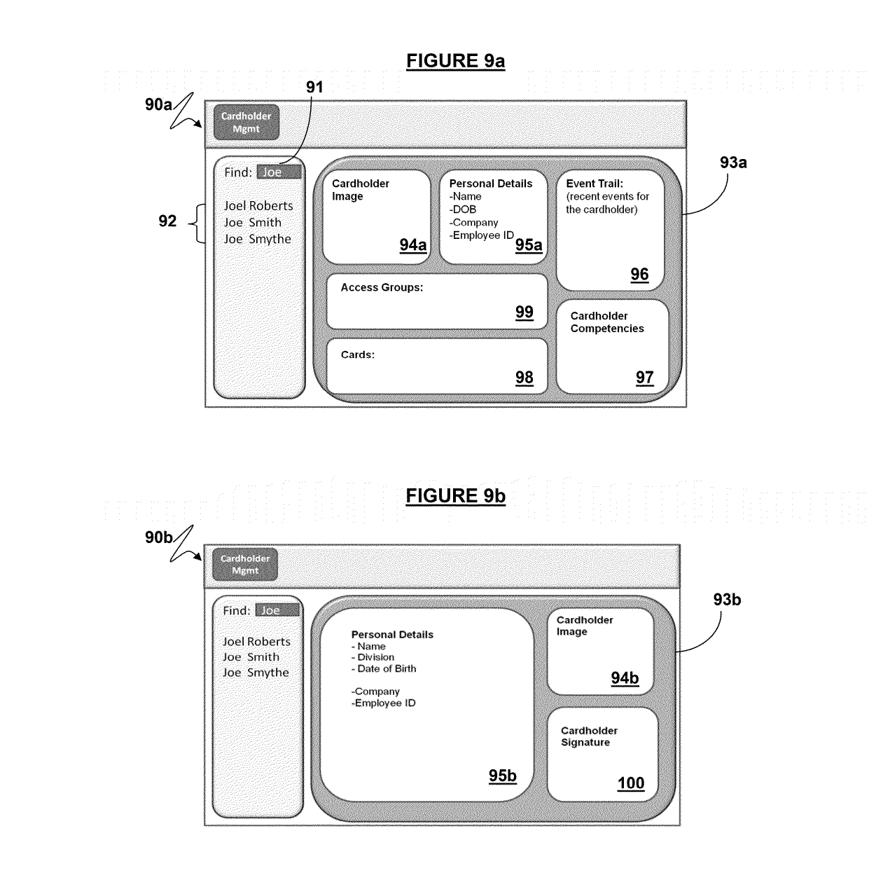

In FIG. 9a, the operator graphical user interface (90a) enables searching of access cardholders.

A searching field (91) enables the operator to search for a cardholder—whether by name, card number, or personal data (company, department, employee ID etc).

A list of suggested results (92) are displayed for selection by the operator. The panel (93a) associated with the ‘Cardholder Management’ heading has been configured by the security manager to display tiles comprising:
Cardholder Image(s) (94a);
Cardholder name and personal details comprising name, date of birth, company, and employee ID (95a);
An event trail recording recent activity by the cardholder (96);
Cardholder competencies, cards or access (97);
Cards held by the cardholder (98); and
Access groups the cardholder belongs to (99).

FIG. 9b, illustrates an alternative configuration of a operator graphical user interface (90b) in comparison to that of FIG. 9a.

The panel (93b) associated with the ‘Cardholder Management’ heading has been configured by the security manager to display tiles comprising:
Cardholder Image(s) (94b);
Cardholder name and personal details comprising name, division, date of birth, company, and employee ID (95b); and
An image of the cardholder's signature (100).

Aspects of the present invention have been described by way of example only and it should be appreciated that modifications and additions may be made thereto without departing from the scope thereof as defined in the appended claims.

What we claim is:

1. A security system, comprising:
a plurality of security devices configured to output at least one signal relating to operation of those devices;
a processor configured to process the output signals to obtain information relating to operation of the devices;
a display device;
a graphical user interface configured to:
instruct the display device to display a number of tiles,
wherein the tiles contain content derived from the information relating to the operation of the devices,
and wherein the graphical user interface is configured to enable external input to the system by a user to determine the tiles to be displayed on the display device and/or content thereof.

2. A security system as claimed in claim 1, wherein the graphical user display is configured to present selectable options to the user to define conditions under which the tiles and/or content thereof are displayed on the display device.

3. A security system as claimed in claim 2, wherein the selectable options comprise options for designation of operators of the system for whom the tiles and/or content associated with a particular condition are displayed.

4. A security system as claimed in claim 2, wherein the selectable options comprise options for designation of the tiles and/or content to be displayed in response to determination of an alarm condition within the information relating to operation of the devices.

5. A security system as claimed in claim 4, wherein the selectable options comprise options for selecting a priority of a type of alarm condition.

6. A security system as claimed in claim 4, wherein the selectable options comprise an option as to whether to display only escalated alarm conditions.

7. A security system as claimed in claim 2, wherein the selectable options comprise an option for selecting at least one area of a site in which the security devices are located to associate with a particular condition.

8. A security system as claimed in claim 1, wherein the graphical user interface is configured to:
cause the display device to display a number of headings related to an aspect of the operation of the security system; and
receive external input from a user to select a heading; and
display tiles relating to the selected heading, wherein the relationship between the displayed tiles and heading are input to the system by the user via the graphical user interface.

9. A method of configuring a security system comprising a plurality of security devices configured to output at least one signal relating to operation of those devices, a processor configured to process the output signals to obtain information relating to operation of the devices, a display device, a graphical user interface configured to instruct the display device to display a number of tiles, wherein the tiles contain content derived from the information relating to the operation of the devices, the method comprising:
a user inputting via the graphical user interface the tiles to be displayed on the display device and/or content thereof.

10. A method as claimed in claim 9, wherein the input by the user forms part of initialisation of the security system.

11. A method as claimed in claim 9, comprising the step of receiving options selected by the user to define conditions under which the tiles and/or content thereof are displayed.

12. A method as claimed in claim 11, wherein the selected options designate operators of the system for whom the tiles and/or content associated with a particular condition are displayed.

13. A method as claimed in claim 11, wherein the selected options designate the tiles and/or content to be displayed in response to determination of an alarm condition within the information relating to operation of the devices.

14. A method as claimed in claim 13, wherein the selected options select a priority of a type of alarm condition.

15. A method as claimed in claim 13, wherein the selected options choose whether to display only escalated alarm conditions.

16. A method as claimed in claim 11, wherein the selected options select at least one area of a site in which the security devices are located to associate with a particular condition.

17. A non-transitory processor-readable medium having stored thereon processor-executable instructions which when executed by a processor cause the processor to perform a method of configuring a security system comprising a plurality of security devices configured to output at least one signal relating to operation of those devices, a processor configured to process the output signals to obtain information relating to operation of the devices, a display device, a graphical user interface configured to instruct the display device to display a number of tiles, wherein the tiles contain content derived from the information relating to the operation of the devices, the method comprising:
a user inputting via the graphical user interface the tiles to be displayed on the display device and/or content thereof.

18. A method of operating a security system comprising:
outputting at least one signal from a plurality of security devices, wherein the at least one signal relates to operation of those devices;
processing the output signals to obtain information relating to operation of the devices;
displaying a number of tiles on a display device, wherein the tiles contain content derived from the information relating to the operation of the devices, and wherein the tiles to be displayed on the display device and/or content thereof are determined by receiving external input by a user via a graphical user interface.

19. A method as claimed in claim 18, wherein the external input is received as part of initialisation of the security system.

20. A method as claimed in claim 18, comprising the step of displaying the tiles and/or content thereof according to options selected by the user via the graphical user interface.

21. A method as claimed in claim 20, comprising determining an alarm condition within the information relating to the operation of the devices.

22. A method as claimed in claim 21, comprising the step of displaying tiles and/or content thereof associated with the alarm condition to operators selected by the user via the graphical user interface.

23. A non-transitory processor-readable medium having stored thereon processor-executable instructions which when executed by a processor cause the processor to perform a method of operating a security system, the method comprising:
outputting at least one signal from a plurality of security devices, wherein the at least one signal relates to operation of those devices;
processing the output signals to obtain information relating to operation of the devices;
displaying a number of tiles on a display device, wherein the tiles contain content derived from the information relating to the operation of the devices, and wherein the tiles to be displayed on the display device and/or content thereof are determined by receiving external input by a user via a graphical user interface.

24. A graphical user interface configured to display a number of tiles via a display device,
wherein the tiles contain content derived from information relating to the operation of a plurality of security devices, the information obtained by processing at least one signal output by the security devices,
and wherein the graphical user interface is configured to enable external input by a user to determine the tiles to be displayed on the display device and/or content thereof.
